(19) United States
(12) Patent Application Publication
(10) Pub. No.: US 2025/0305843 A1
(43) Pub. Date: Oct. 2, 2025

(54) Vehicular Edge Intelligence in Unlicensed Spectrum Bands

(71) Applicants: Northeastern University, Boston, MA (US); Politecnico di Torino, Torino (IT)

(72) Inventors: Francesco Raviglione, Biella (IT); Francesco Restuccia, Boston (MA); Claudio Casetti, Torino (IT)

(21) Appl. No.: 18/844,869

(22) PCT Filed: Mar. 23, 2023
(86) PCT No.: PCT/US2023/064848

§ 371 Date: Sep. 6, 2024

Related U.S. Application Data
(60) Provisional application No. 63/269,971, filed on Mar. 25, 2022.

(51) Int. Cl. G01C 21/36; H04W 4/38; H04W 4/44; H04W 16/14

(52) U.S. Cl. CPC G01C 21/3605; H04W 4/38; H04W 4/44; H04W 16/14

(57) ABSTRACT

An on-board vehicle system manages operations and communications of the vehicle. A wireless network interface communicates with remote devices via multiple wireless channels. A computing module maintains a local dynamic map (EDM) representing the vehicle and a surrounding environment. A controller generates a navigation task from sensor data corresponding to the surrounding environment, and communicates with the computing module to determine a status of on-board computational resources. Based on the EDM and the status of on-board computational resources, the controller determines a destination, to process the navigation task. The destination can potentially include on-board and remote resources. The controller communicates the navigation task to the destination and facilitates an update to the EDM based on the result.

### RELATED APPLICATION

This application is the U.S. National Stage of International Application No. PCT/US2023/064848, filed Mar. 23, 2023, which designates the U.S., published in English, and claims the benefit of U.S. Provisional Application No. 63/269,971, filed on Mar. 25, 2022. The entire teachings of the above applications are incorporated herein by reference.

### GOVERNMENT SUPPORT

This invention was made with government support under Grant Number 2134973 awarded by the National Science Foundation. The government has certain rights in the invention.

### BACKGROUND

Innovations in edge computing and wireless connectivity are paving the way for smarter, safer, and greener autonomous vehicles. The self-driving car market is expected to expand rapidly worldwide. Making vehicles smarter implies making them more aware of their immediate surroundings. To this end, high-bandwidth Vehicle-to-Vehicle (V2V) connectivity is needed to enable technologies such as “see-through,” where vehicles share their on-board sensor data (e.g., camera, LIDAR, radar) to aid vehicle passing, stopping for pedestrian crossings, or noticing an upcoming detour. Other uses cases include the real-time sharing of high-definition maps among self-driven vehicles for accurate localization or interactive entertainment systems for passengers based on V2V communication.

### SUMMARY

Example embodiments include a system for managing operation of a vehicle. A wireless network interface may be configured to communicate with remote devices via at least a first wireless channel and a second wireless channel. A computing module may be configured to maintain a local dynamic map (LDM) representing the vehicle and a surrounding environment. A controller may be configured to 1) generate a navigation task from sensor data corresponding to the surrounding environment, 2) communicate with the computing module to determine a status of on-board computational resources, 3) determine, based on the LDM and the status of on-board computational resources, a destination to process the navigation task, the destination being one of a set of resources including the computing module and at least one of the remote devices, and 4) communicate the navigation task to the destination via at least one of an on-board channel and the first and second wireless channels.

The navigation task may include processing the sensor data to determine an update to the LDM, and may be a deep learning (DL) task. The first wireless channel may be a dedicated short-range communications (DSRC) channel, and the second wireless channel may be a point-to-point millimeter wave (mmWave) channel. The computing module may be further configured to update the LDM based on communications from the remote devices via the DSRC channel. The controller may be further configured to communicate the navigation task to the destination via the mmWave channel, the destination being one of a remote vehicle and a road side unit (RSU). The RSU may be further configured to communicate the navigation task to a cloud network resource for performing the navigation task.

The controller may be further configured to: generate a first feature set representing the set of resources; generate a second feature set representing the navigation task; apply the first and second feature sets to a classifier to determine the destination. Alternatively, the controller is further configured to: incorporate a representation of the set of resources and a representation of the navigation task into a mathematical model; and process the mathematical model to determine the destination.

At least one of the distinct spectrum bands may be an unlicensed spectrum band. The computing module may be further configured to control movement of the vehicle based on the LDM, the movement including at least one of collision avoidance and self-driving operation. The first and second wireless channels may have distinct spectrum bands.

Further embodiments include a method of managing operation of a vehicle. Remote devices may be communicated with via at least a first wireless channel and a second wireless channel. A local dynamic map (LDM) representing the vehicle and a surrounding environment may be maintained. A navigation task may be generated from sensor data corresponding to the surrounding environment. An on-board computing module may be communicated with to determine a status of on-board computational resources. Based on the LDM and the status of on-board computational resources, a destination to process the navigation task may then be determined, the destination being one of a set of resources including the on-board computing module and at least one of the remote devices. The navigation task then be communicated to the destination via at least one of an on-board channel and the first and second wireless channels.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of a vehicle network in which example embodiments may be implemented.

FIG. 2 is a block diagram of a vehicle management system in one embodiment.

FIG. 3 is a flow diagram of a process of managing navigation tasks in one embodiment.

FIG. 4 is a block diagram of a vehicle management system in a further embodiment.

### DETAILED DESCRIPTION

A description of example embodiments follows. The teachings of all patents, published applications and references cited herein are incorporated by reference in their entirety.

Cutting-edge advances in wireless networking will soon enable a new generation of safer, smarter, and more autonomous vehicles. For navigation purposes, smart vehicles will require real-time execution of complex Deep Learning (DL) tasks (e.g., image segmentation) as well as high-speed multimedia streaming between vehicles. Critically, existing vehicular technologies such as Cellular Vehicle-to-Everything (C-V2X) Mode 4 and IEEE 802.11p do not address these requirements. On the other hand, cellular networking (i) puts an unnecessary burden on an already overcrowded and expensive licensed spectrum; (ii) increases DL task latency to intolerable levels for vehicular applications.

In contrast, example embodiments provide a framework enabling practical vehicular edge intelligence and high-speed vehicular connectivity in unlicensed bands. Example systems can leverage IEEE 802.11p to acquire real-time localized knowledge, and coordinates the usage of point-to-point millimeter wave (mmWave) technologies to deliver high-bandwidth connectivity between vehicles. To optimally allocate DL tasks and other navigation tasks between the vehicular edge, remote devices, and the cloud, the vehicular edge intelligence problem (VEIP), which takes into account the current vehicle position and computational capabilities to minimize total task delay is mathematically formulated below. VEIP is NP-Hard, and an approximation algorithm to solve it efficiently is described below. Example embodiments can decrease end-to-end latency significantly (e.g., down to 5 ms), with up to 65% reduction with respect to cellular/cloud-based approaches when offloading DL tasks.

A significant challenge is that on-board sensors such as LIDAR can generate up to Terabytes per hour of data. Thus, using 5G cellular networks (5G) connectivity would put enormous stress on the already overloaded licensed spectrum bands, expected to support up to 64 billion subscriptions by 2025. In addition, real-time analysis of sensor data requires sophisticated Deep Learning (DL) algorithms, such as image segmentation to detect the road. Conversely, Vehicular Edge Intelligence (VEI), as exemplified in the embodiments describe below, (i) reduces the usage of expensive 5G spectrum, (ii) reduces task latency through V2V cooperation, and (iii) may prove essential where 5G is limited or absent. Existing vehicular technologies such as Cellular-V2X Mode 4 and IEEE 802.11p cannot guarantee VEI requirements, as their peak data rates are typically below 30 Mbit/s. Although millimeter wave (mmWave) vehicular networking has been proposed, existing work is mostly based on simulations, without any practical demonstration. Prior work proposes approaches where mmWave is used as a standalone, cure-all solution; however, it is well known that mmWave suffers from relatively high path loss and loss of connectivity due to blockages. For this reason, it is critical to combine the action of different wireless technologies to concretely realize the much-needed VEI.

Example embodiments provide a framework enabling and demonstrating Vehicular Edge Intelligence in practical scenarios. Such embodiments enable high-bandwidth, reliable and effective VEI while operating in communications channels including those of unlicensed spectrum. In one example, this result may be achieved through the combined usage of 60 GHz mmWave connectivity, V2X-specific Intelligent Transportation System (ITS) links using the 5.9 GHz Dedicated Short-Range Communications (DSRC) band, data exchange through IEEE 802.11ac Wi-Fi at 5 GHz, as well as and the exchange of VEI-specific information among vehicles.

VEI brings forth the problem of choosing when, where and which vehicles should be selected for executing DL tasks. In particular, the Vehicular Edge Intelligence Problem (VEIP) defines where vehicles need to select where to offload DL tasks based on (i) current vehicle's positions and connectivity status, as well as (ii) current DL task constraints. VEIP is NP-Hard, and in one example described below, a “greedy” algorithm may be implemented to solve it in polynomial time.

Example embodiments may be built using off-the-shelf hardware equipment. For example, embodiments may use a combination of low-cost off-the-shelf evaluation boards of IEEE 802.11p, IEEE 802.11ad and IEEE 802.11ac chips, and may be controlled by Linux-based open-source code. Such embodiments may include a highly-efficient Local Dynamic Map (LDM) to store information about vehicle dynamics, the current computational load of those vehicles, and about the current network topology. Embodiments may further include a container for the latest European Telecommunications Standards Institute (ETSI) ITS-G5 Cooperative Awareness Message (CAM) version to support the exchange of channel-related (e.g., RSSI, MCS) and load-related information, e.g., CPU, GPU, RAM usage.

Example embodiments may facilitate direct data exchange between vehicles and DL-based object detection in a VEI context. Larger DL tasks benefit more from local distributed computing than smaller tasks, when leveraging heuristics to solve VEIP. Example embodiments are able to provide latency up to 65% lower than the usage of cloud-only approaches when performing DL tasks, while decreasing the mAP by only 18%. Further, the combination of mmWave and sub-6 GHz connectivity can provide end-to-end latency of less than 5 ms.

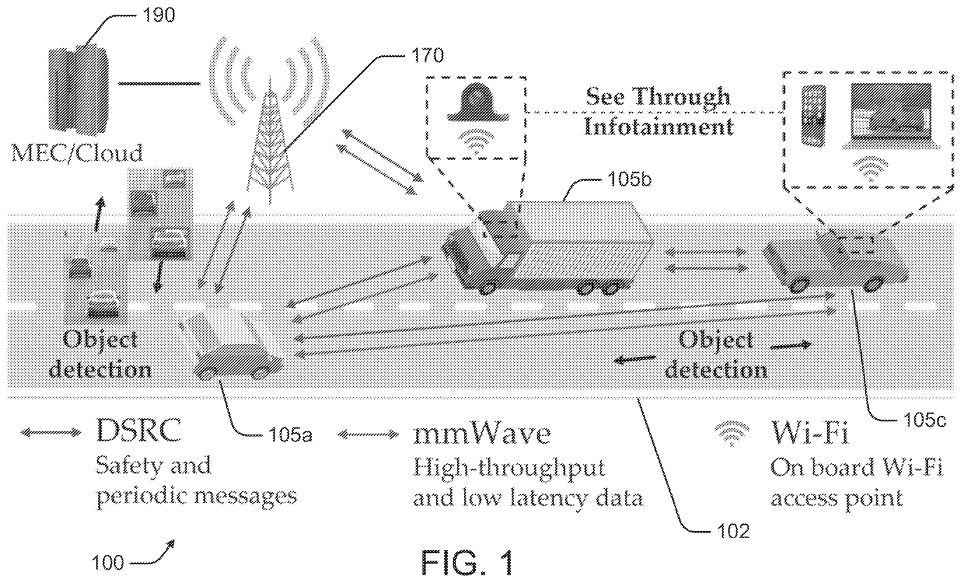

FIG. 1 is a diagram of a vehicle network 100 in which example embodiments may be implemented. As shown, vehicles 105a-c are networked to one another via DSRC and mmWave communications channels as they maneuver along a road 102. The vehicles 105a-b within range of a road side unit (RSU) 170 (e.g., a wireless router connected to the Internet or another network) may also connect with the RSU 170 via the same channels. Thus, the vehicles 105a-c and the RSU 170 may operate as nodes of the vehicle network 100, which in turn may connect to multi-access edge computing (MEC) or other cloud resources 190 via the RSU 170.

Each of the vehicles 105a-c may utilize the network 100 in several ways. For example, each vehicle 105a-c may maintain a local dynamic map (LDM), which informs the vehicle of the surrounding environment and the remote vehicles within it. The LDM can be populated and updated by messages exchanged via the DSRC channels between the vehicles 105a-c and the RSU 170 in addition to data from the on-board sensors of each vehicle 105a-c. The nodes may also exchange other messages via the DSRC band, such as safety and periodic messages under the intelligent transportation system (ITS) protocol. Further, the nodes 105a-c, 170 may communicate messages requiring high throughput and low latency, such as those relating to object detection and other navigation tasks, via the mmWave channels. For example, the vehicle 105a may transmit data for an object detection task, which involves processing images captured by the vehicle's 105a onboard cameras and/or other sensors, to a nearby vehicle 105b or the RSU 170 (i.e., the destination) for completion. If the RSU 170 is the destination, it may in turn forward the task to the MEC or other cloud resources 190 to generate a task result, and then forward the task result to the vehicle 105a via a response mmWave message. The vehicle 105a, in turn, may update its LDM based on the task result to indicate the position and properties of new and existing objects within its environment.

The vehicles 105a-c may also utilize the mmWave channels to provide other technologies requiring high-bandwidth vehicle-to-vehicle (V2V) connectivity, such as “see-through,” wherein the vehicles 105a-c share their on-board sensor data (e.g., camera, LIDAR, radar) to aid vehicle passing, stopping for pedestrian crossings, or detecting an upcoming detour. Further, each vehicle 105a-c may also include a Wi-Fi access point for wirelessly linking on-board systems, such as sensors, display screens, and user devices (e.g., smartphones, laptops) with the vehicle's management system.

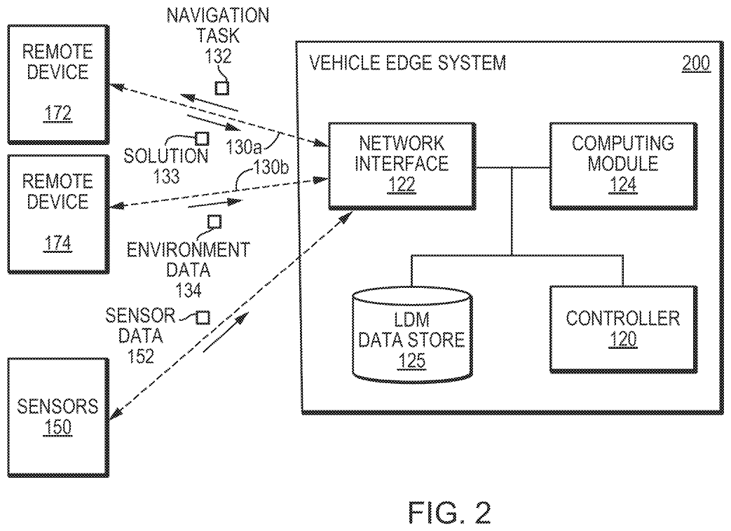

FIG. 2 is a block diagram of a vehicle management system 200 in one embodiment.

The system 200 may be implemented in any of the vehicles 105a-c described above, and may provide several services to the vehicle, such as monitoring the vehicle's environment, communicating with other vehicles and RSUs, and control vehicle operation such as collision avoidance and self-driving operation. The system 200 may include a network interface 122, a computing module 124, a controller 120, and a LDM data store 125. The network interface 122 may communicate with remote devices 172, 174 (e.g., other vehicles and RSUs) via multiple wireless channels 130a-b (e.g., a DSRC channel and a mmWave channel). The computing module 124 may maintain, at the LDM data store 125, a local dynamic map (LDM) representing the vehicle and a surrounding environment. The controller 120 may manage operation of the system 100 by generating navigation tasks (e.g., object detection) and delegating resources for completing those tasks.

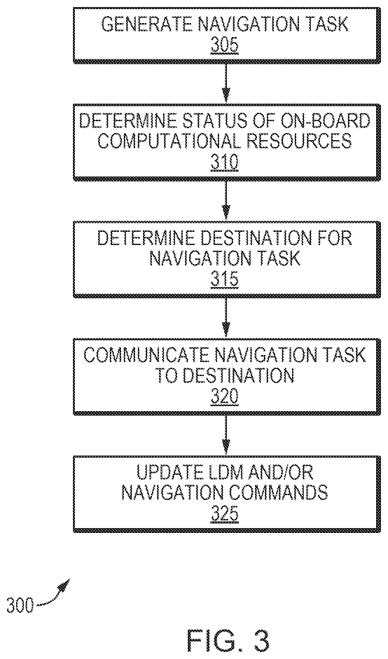

FIG. 3 is a flow diagram of a process 300 of managing navigation tasks. With reference to the system 200 of FIG. 2, the system 200 may receive, through the network interface 122, sensor data 152 corresponding to the surrounding environment generated by one or more on-board sensors 150 (e.g., cameras, LIDAR). The computing module 124 may process this data 152, along with environment data 134 (e.g., the position and velocity of remote vehicles) received from remote devices 172, 174, to update the LDM at the LDM data store 125. As a result, the system 200 can maintain an accurate and current representation of the environment, enabling to computing module 124 to safely perform vehicle operations such as collision avoidance, self-driving operation, and other movement control.

However, the computing module 124 may have limited resources for processing all of the sensor data 152 over time, as well as updating the LDM based on the environment data 134 from the remote devices 172, 174. Accordingly, the controller 120 may manage delegation of such processing among on-board and external resources. In particular, from the sensor data 152, the controller 120 may generate a navigation task, such as the detection of objects in the environment (305). The controller 120 may then communicate with the computing module 124 to determine the status of on-board computational resources, such as the availability of processing cores at the computing module 124 to complete the navigation task within an acceptable timeframe (310). The controller 120 may also maintain a representation of available computing resources of the remote devices 172, 174, which may be communicated periodically to the system 200 in the environment data 134. This information on remote resources may be integrated into the LDM, for example.

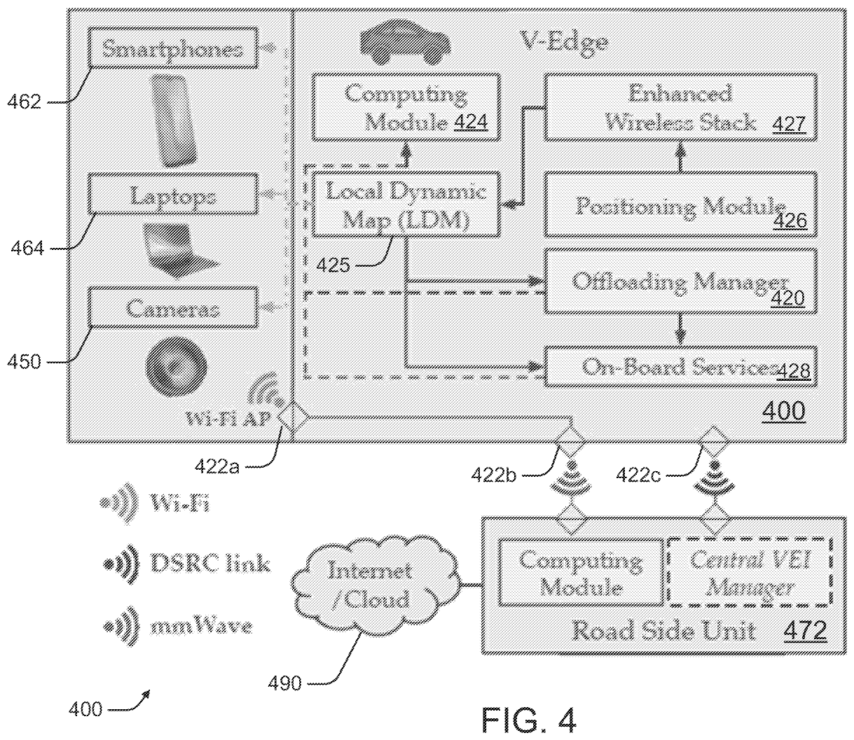

The controller 120 may then determine, based on the LDM and the status of on-board computational resources, a destination to process the navigation task (315). The destination may be, for example, the computing module 124 or one of the remote devices 172, 174. Optionally, the navigation task may be divided into a plurality of sub-tasks that are distributed among multiple distinct destinations. A detailed example of delegation of navigation tasks is described in further detail below with reference to FIG. 4. With the destination determined, the controller 120 may then communicate the navigation task to the destination via an on-board channel or one of the wireless channels 130a-b (320). Upon obtaining a processed result corresponding to the navigation task, the controller 120 or computing module 124 may respond accordingly, for example by updating the LDM at the LDM data store 125, and/or by issuing or modifying navigation commands to maneuver the vehicle.

FIG. 4 is a block diagram of a vehicle management system 400 in a further embodiment. The system 400 may include some or all of the elements of the system 100, but is presented in FIG. 4 largely as functional blocks rather than distinct hardware components. In particular, the system may include radio interfaces 422a-c comparable to the network interface 122 describe above. As shown, the system 400 is equipped with three radio interfaces, two of which are external (directional mmWave 422b and DSRC 422c), and a Wi-Fi Access Point (AP) interface 422a that is internal to the vehicle. The Wi-Fi interface 422a may be bridged with the mm Wave interface 422b to provide the on-board devices with access to the Internet, for example through a Road Side Unit (RSU) 472, allowing them to communicate seamlessly between each other and between different vehicles equipped with mmWave. These devices may include cameras on board of different vehicles, enabling use cases such as see-through capability. Further, the presence of the RSU 472 enables a data exchange between the on-board devices through the RSU itself, realizing, if needed, a mmWave V2I2V (vehicle-to-infrastructure-to-vehicle) communication. This approach enables the exchange of data between vehicles even in case of noticeable non-line-of-sight (NLOS) blockage or distances higher than a few hundreds of meters.

The computing module 424 may be comparable to the computing module 124 described above, and represents computing resources (e.g., CPU(s), GPU(s) and RAM) that can be used to execute tasks and on-board services locally, or can be exploited by other nodes to offload their tasks. The RSU 472 may also include a comparable computing module configured to execute navigation tasks communicated by the system 400, or may forward some or all of the tasks to cloud-based resources 490 for completion. The LDM 425 may be a standard-compliant enhanced LDM, which can be leveraged to optimize decisions such as where to offload data, or to determine dangerous road conditions. The LDM 425 may include, among others, computational load and channel load metrics for each vehicle stored in the map. The LDM 425 may provide enhanced awareness and may be populated through standard-compliant vehicular messages, exchanged through the DSRC link. Furthermore, the LDM 425 can receive messages from both other vehicles (through multi-hop) or from the RSU 472. This enables the offloading manager 420 to have situational awareness and lets it compute the number of mm Wave hops which may be needed to reach each node.

The enhanced wireless stack 427 may be a standard-compliant ITS stack, enhanced to include an optional container in periodic messages, e.g., CAMs in Europe, basic safety messages in the US, for the exchange of channel and node load information. The enhanced ITS messages may be broadcast through the DSRC link. The positioning module 426 may include an embedded or external Global Navigation Satellite System (GNSS) receiver, which provides dynamic data to the ITS stack for the generation of standard-compliant messages. The positioning module 426 provides geographical positioning information to the stack, which is in turn provided to the LDMs of the remote vehicles in the surrounding environment. The positioning information is one of the key data leveraged by the Offloading Manager to perform the decision process of delegating tasks.

The Offloading Manager (OM) 420 may be comparable to the controller 120 described above, and determines which of the available resources (i.e., the computing module 424, the RSU 472, cloud resources 490, and other vehicles) are best to perform task offloading and to communicate with, and decides which is the best link to use to communicate those tasks. This decision may be based upon on the information available in the LDM and on AI-based algorithms or mathematical optimization operated by the OM 420. To reach this decision, the OM 420 may solve the VEIP as described below. The OM 420 may also be used to manage the local computing resources and to determine the best route towards any destination in case multiple mmWave hops are required. Indeed, when performing high-speed data exchange between on-board devices, the OM 420 can determine which is the best route and provide it to the related on-board services 428. The on-board services 428 may be a subset of the computing module 124 described above, and may operate core V2X services for the system 400, including, for example, see-through, collision avoidance, object detection through task offloading, automated maneuver management and many others. The V2X services can retrieve useful data either from the ITS stack or from the high capacity mmWave link, and can leverage the on-board computing resources. They can also directly retrieve dynamic, node and channel load and network data from the LDM 425.

The system 400 may communicate with the RSU 472 for connection to the broader Internet, thereby enabling further offloading of DL-based tasks to the cloud in the event that no vehicles have enough on-board resources to reach the desired results. Optionally, a central VEI Manager may be deployed at the RSU 472 to centrally manage group of vehicles in a centralized VEI approach. However, the system 400 may operate independently from a centralized unit.

In an example operation, the system 400 may provide low-latency navigation task offloading. Navigation tasks (e.g., DL tasks) may be generated through multimedia sensors and captured through the network interface 422a. Concurrently, the system 400 may be receiving enhanced ITS messages via the DSRC interface 422c that it uses to populate the LDM. As navigation tasks are being generated, the OM 420 may check the available on-board resources, and may directly gather this information from the computing module 424. If there are not enough resources at the system 400, the OM 420 may select the best remote devices to offload the task. To compute the needed information, the OM 420 may leverage the LDM, solve an optimization problem as described below, and provide the result to the on-board services 428. The on-board services 428 may then offload the tasks via the mm Wave interface 422b.

### Vehicular Edge Intelligence Problem (VEIP)

The example below is a mathematical formulation and solution of the vehicular edge intelligence problem (VEIP), which can be implemented in the controller 120 or OM 420 described above. For each navigation task, the OM may decide (i) which location tasks should be offloaded to (either other vehicles or the cloud); (ii) how many resources should be reserved on the same vehicles (or requested to the cloud); (iii) in the case the task is splittable, which fraction of each task should be assigned to each destination node. Sources are defined as vehicles that may offload tasks to other nodes (i.e., other vehicles or the cloud). Through the shared knowledge built via to the DSRC link, each source can be aware of the full mmWave network topology. Each source i, at a given time slot, may have several tasks to be fulfilled. The term fᵢ is defined as the number of computations needed for the tasks of each source i with respect to a given reference system (e.g., a given platform with a certain CPU and GPU). No constraints on the available RAM and disk in the destination nodes are presumed. Several input quantities are defined as follows, all referring to a single time slot:

I1: N={1, . . . , n, k}, |N|=ν, set of all the available n connected nodes; beside the connected vehicles, k is a special node modelling the access to the cloud, which can be accessed from all the vehicles.

I2: S⊆N, |S|=ξ, set of all the source vehicles generating (and possibly performing) tasks at a given rate.

I3: E={(w, z): d_{wz}<dₗᵢₘ∧RSSIwz≥RSSIₗᵢₘ}∪{w, k}, 1≤w≤n, 1≤z≤n, set of edges between nodes, i.e., active mmWave links with a good-enough signal. Furthermore, dlim is the distance limit above which any mmWave link is considered unstable, while RSSIlim is the RSSI limit below which any mmWave is considered unstable.

I4: G=(N, E), graph of the current network topology, whose edges are represented by valid mmWave links.

I5: C_{c}={c₁, . . . , c_{ν}}, set of the currently available computational capacity of each node, in terms of computations per second, with respect to a given reference system, as defined for fi. The computational capacity is a function of the available CPU and GPU for each node j: c j=α (CPU j,GPU j).

I6: Ri j={(i, h₁, . . . , h_{z}, j): (i, h₁)∈E, (h_{z}, j)∈E, (hᵢ, hᵢ₊₁)∈E, 1≤i≤z−1}, set of all routes from each source i to any possible destination j∈N in the network.

I7: L(i, j), latency of the route from source i to destination j. Assuming a symmetric channel, the Round Trip Time (RTT) can be represented by 2·L(i, j). This term depends on the amount of data Di j which needs to be transmitted from each source vehicle to each destination node, and on the average wireless channel data rate bi j. In turn, Di j depends on the actual task fraction assignment to each destination node: Di j=β(τi j), where β maps the task fraction to each destination node to the amount of data which needs to be sent to that node.

I8: oⱼ, overhead time of each destination node j. This time accounts for the overhead due to the message reception in the target operating system, data encoding and decoding and all the operations which do not depend on the size of the actual task.

Likewise, for every time slot, the following output quantities and sets may be defined:

O1: A*i={(aᵢ₁, . . . , a_{iν}}, set of optimal resource assignment to each node in the network for the current source i. All the nodes j such that ∃(a_{i j}>0) will be destination nodes towards which the tasks are offloaded. Each ai j is defined in terms of computations per second.

O2: D⊆N, set of selected destination nodes to which the tasks should be offloaded.

O3: T*i={(τ_{i 1}, . . . , τ_{i ν}}, set of optimal task subdivision to each node in the network for the current source i. Each τ_{i j} represents the fraction of task fᵢ assigned to destination node j. Each destination node j∈D should have at least one non-zero τ_{i j}, while each non-destination node j should have all its τ_{i j}=0.

R*ᵢⱼ may be defined as the set of selected optimal routes from each source i to the chosen destinations j. Under the above definitions, the VEIP may be modeled as follows:

$$Find D ⊆ N : \{ 1 \leq j \leq ν : ∃ ( {a}_{ij} > 0 ) , 1 \leq i \leq ξ \} \qquad ( 1 a )$$

$${ℝ}_{ij}^{*} ⊆ {ℝ}_{ij} , 1 \leq i \leq ξ \qquad ( 1 b )$$

$${𝔸}_{i}^{*} , 1 \leq i \leq ξ \qquad ( 1 c )$$

$${𝕋}_{i}^{*} , 1 \leq i \leq ξ \qquad ( 1 d )$$

such that:

$$minimize i , j {\sum }_{i ∈ s} {\sum }_{j = 1}^{ν} \{ 2 \cdot L ( i , j ) + \frac{τ ij}{a i j} + {o}_{j} \} \cdot {y}_{i j} \qquad ( 1 e )$$

$$subject to : {\sum }_{i} {a}_{ij} \leq {c}_{j} , ∀ j \qquad ( 1 f )$$

$${\sum }_{j} {a}_{ij} > 0 , ∀ i \qquad ( 1 g )$$

$$yij = \{ \begin{matrix}1 & if {a}_{ij} > 0 \\ 0 & otherwise\end{matrix} , ∀ i , j \qquad ( 1 h )$$

$${\sum }_{j} {t}_{ij} = {f}_{i} , ∀ i \qquad ( 1 i )$$

$${t}_{ij} \leq M \cdot {y}_{i j} , ∀ i \qquad ( 1 j )$$

$${t}_{ij} \geq {τ}_{min} \cdot {y}_{i j} , ∀ i \qquad ( 1 k )$$

The sets (1a) and (1b) define the selected destination nodes and routes from sources to destinations. The objective function (1e) minimizes the overall latency. The first term represents the RTT of the path towards the destination node, while the second term is the computation latency, defined as the ratio between the number of computations needed to fulfill tasks from source vehicle i and the resources (number of computations per second) assigned to the destination node j for the tasks of source node i. The third term is the overhead time. Constraint (1f) is the capacity constraint (i.e., a node cannot be assigned more capacity than its current availability), while constraint (1g) forces each task to be executed. The support variable y_{i j} is defined to take into account that a node j with all its a_{i j}=0 is not being chosen as a destination node, and thus should not contribute to the overall latency. Furthermore, constraint (1i) forces each task from source i to be completely fulfilled by the selected destination nodes j. Finally, constraints (1j) and (1k) make each destination node j with a_{i j}>0 perform at least a fraction of task τ_{i j}, and each non-destination node j with a_{i j}=0 perform no computations for the current task fᵢ. Indeed, M represents an upper bound to the value of each τ_{i j}, while τₗᵢₘ is a lower bound to the value of each τ_{i j}.

The problem can be reduced to a Multiple Knapsacks problem under the following assumptions: (i) tasks are allowed to be unfulfilled (this removes Constraint (1g)), (ii) a single hop problem, in which there is no propagation nor transmission and overhead time, i.e., L(i, j)=0, oⱼ=0, ∀ᵢ, j, (iii) The problem may now be unsplittable, which allows us to replace τi j with fᵢ (only one destination node can be selected to fulfill the whole task) and remove constraints from (1i) to (1k), (iv) The same amount of computations per second is required to each destination node to fulfill tasks from each source i. (iv) allows for rewriting each a_{i j} as x_{i j}∈{0, 1}, as the problem becomes now finding which destination could fulfill our task. x_{i j} will be thus equal to 1 if a given destination j is going to fulfill tasks from source i. The problem can then be rewritten as max:

$${\sum }_{j}^{v} {\sum }_{i}^{ξ} ( - {f}_{i} \cdot {x}_{ij} )$$

subject to:

$${\sum }_{i} {f}_{i} \cdot {x}_{ij} \leq {c}_{j} , ∀ j$$

This problem is a Multiple Knapsacks Problem, which is NP-Hard, thus also the VEIP is NP-Hard.

An example algorithm to solve the VIEP (referred to as DG-VEIP), described below, is an efficient distributed greedy algorithm. Here, it is presumed that the cloud resources are always available and that L(i, j) has been properly set depending on the scenario and on the set of tasks. DG-VEIP may be executed for each source vehicle i.

| | |
|---|---|
| 1: | Define an empty list of vehicles V |
| 2: | Define the remaining task fraction to be assigned τᵣₑₘ ← fᵢ |
| 3: | for n ∈ N: path between i and n exists in [symbol] ᵢⱼ do |
| 4: | if n ≠ k then |
| 5: | $Compute \frac{{d}_{n}}{{c}_{n}}$ |
| 6: | else |
| 7: | $\frac{{d}_{n}}{{c}_{n}} ← ∞$ |
| 8: | end if |
| 9: | $Add node to list V , ordered by ascending \frac{{d}_{n}}{{c}_{n}}$ |
| 10: | end for |
| 11: | for υ ∈ V and τᵣₑₘ > 0 do |
| 12: | if c_{υ} > 0 then |
| 13: | Request all available capacity to the node: a_{iυ} ← c_{υ} |
| 14: | if υ ≠ k then |
| 15: | c_{υ} ← 0 |
| 16: | end if |
| 17: | Assign task fraction τ_{iυ} such that it is completed before |
| | or in a tᵢ time |
| 18: | τᵣₑₘ ← τᵣₑₘ − τ_{iυ} |
| 19: | end if |
| 20: | end for |

Each source vehicle i generates a number of tasks to be executed at each time step tᵢ. These tasks are represented by the number of total computations needed fᵢ. Each vehicle, using the LDM, can scan the list of the N connected nodes (which can include the vehicle itself at dₙ=0), and add them to a new list V, which is sorted in ascending order by the ratio of the distance and the available node capacity (referred to as cost). The cloud node is artificially assigned the highest ratio among all other nodes (ideally ∞), so that it will be selected last, only if needed. The algorithm then loops over all the nodes in V until all the fᵢ computations have been offloaded (or performed by itself or by the cloud). The variable τᵣₑₘ represents the number of remaining computations which need to be offloaded. If a node in V is found with free computation resources, the source vehicle will require all its capacity, to try to minimize the latency, and assign a task fraction τ_{iν} such that the task is either completed in a ti time, meeting the deadline of the next time frame, or before that time (if the node has more computation resources available). Finally, the cloud may be presumed to have no hard resource limits, and it can thus be always selected as last possibility when no other local vehicles can be selected.

While example embodiments have been particularly shown and described, it will be understood by those skilled in the art that various changes in form and details may be made therein without departing from the scope of the embodiments encompassed by the appended claims.

What is claimed is:

1. A system for managing operation of a vehicle, comprising:
a wireless network interface configured to communicate with remote devices via at least a first wireless channel and a second wireless channel;
a computing module configured to maintain a local dynamic map (LDM) representing the vehicle and a surrounding environment; and
a controller configured to:
generate a navigation task from sensor data corresponding to the surrounding environment;
communicate with the computing module to determine a status of on-board computational resources;
determine, based on the LDM and the status of on-board computational resources, a destination to process the navigation task, the destination being one of a set of resources including the computing module and at least one of the remote devices; and
communicate the navigation task to the destination via at least one of an on-board channel and the first and second wireless channels.

2. The system of claim 1, wherein the navigation task includes processing the sensor data to determine an update to the LDM.

3. The system of claim 1, wherein the navigation task is a deep learning (DL) task.

4. The system of claim 1, wherein the first wireless channel is a dedicated short-range communications (DSRC) channel and the second wireless channel is a point-to-point millimeter wave (mmWave) channel.

5. The system of claim 4, wherein the computing module is further configured to update the LDM based on communications from the remote devices via the DSRC channel.

6. The system of claim 4, wherein the controller is further configured to communicate the navigation task to the destination via the mmWave channel, the destination being one of a remote vehicle and a road side unit (RSU).

7. The system of claim 6, wherein the RSU is further configured to communicate the navigation task to a cloud network resource for performing the navigation task.

8. The system of claim 1, wherein the controller is further configured to:
generate a first feature set representing the set of resources;
generate a second feature set representing the navigation task;
apply the first and second feature sets to a classifier to determine the destination.

9. The system of claim 1, wherein the controller is further configured to:
incorporate a representation of the set of resources and a representation of the navigation task into a mathematical model; and
process the mathematical model to determine the destination.

10. The system of claim 1, wherein at least one of the distinct spectrum bands is an unlicensed spectrum band.

11. The system of claim 1, wherein the computing module is further configured to control movement of the vehicle based on the LDM, the movement including at least one of collision avoidance and self-driving operation.

12. The system of claim 1, wherein the first and second wireless channels have distinct spectrum bands.

13. A method of managing operation of a vehicle, comprising:
communicating with remote devices via at least a first wireless channel and a second wireless channel;
maintaining a local dynamic map (LDM) representing the vehicle and a surrounding environment;
generating a navigation task from sensor data corresponding to the surrounding environment;
communicating with an on-board computing module to determine a status of on-board computational resources;
determining, based on the LDM and the status of on-board computational resources, a destination to process the navigation task, the destination being one of a set of resources including the on-board computing module and at least one of the remote devices; and
communicating the navigation task to the destination via at least one of an on-board channel and the first and second wireless channels.

14. The method of claim 13, wherein the navigation task includes processing the sensor data to determine an update to the LDM.

15. The method of claim 13, wherein the navigation task is a deep learning (DL) task.

16. The method of claim 13, wherein the first wireless channel is a dedicated short-range communications (DSRC) channel and the second wireless channel is a point-to-point millimeter wave (mmWave) channel.

17. The method of claim 16, further comprising updating the LDM based on communications from the remote devices via the DSRC channel.

18. The method of claim 16, further comprising communicating the navigation task to the destination via the mmWave channel, the destination being one of a remote vehicle and a road side unit (RSU).

19. The method of claim 13, further comprising:
generating a first feature set representing the set of resources;
generating a second feature set representing the navigation task;
applying the first and second feature sets to a classifier to determine the destination.

20. The method of claim 13, further comprising:
incorporating a representation of the set of resources and a representation of the navigation task into a mathematical model; and
processing the mathematical model to determine the destination.

21. The method of claim 13, wherein at least one of the distinct spectrum bands is an unlicensed spectrum band.

22. The method of claim 13, further comprising controlling movement of the vehicle based on the LDM, the movement including at least one of collision avoidance and self-driving operation.
